(19) United States
(12) Patent Application Publication
(10) Pub. No.: US 2011/0045126 A1
(43) Pub. Date: Feb. 24, 2011

(54) DRESSING COMPOSITION

(75) Inventors: Ellen Maria Elizabeth Mulder, Wormerveer (NL); Miriam Aldegonda Josephina Van Wanroij, Wormerveer (NL); Ulrike Schmid, Wormerveer (NL); Jeroen Monster, Wormerveer (NL)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: LIPID NUTRITION B.V., Wormerveer (NL)

(21) Appl. No.: 12/740,294

(22) PCT Filed: Oct. 28, 2008
(86) PCT No.: PCT/EP2008/009096

§ 371 Date: Aug. 6, 2010

(30) Foreign Application Priority Data
Oct. 29, 2007 (EP) 07254268.1

(51) Int. Cl. A23L 1/24; A23L 1/302; A23L 1/30

(52) U.S. Cl. 426/2; 426/601; 426/580; 426/583; 426/605; 426/72; 426/541; 426/602

(57) ABSTRACT

A dressing composition comprising a fat phase, said fat phase comprising at least 90% by weight conjugated linoleic acid or a derivative thereof (CLA). There is also disclosed a process for making the dressing composition, and also the use of the dressing composition for a nutritional benefit.

This invention relates to a dressing composition and to a process for its production.

A dressing is a sauce often used to accompany a salad. Dressings are often emulsions formed from an aqueous phase and a fat phase. Examples of dressings include vinaigrette and mayonnaise. A dressing in the form of an emulsion can be prepared so that the phases separate out, or remain emulsified, for example through the use of emulsifiers. Dressings can be oil-in-water emulsions or water in-oil emulsions.

The nutritional value of the diet has come under increasing scrutiny. Food supplements are often taken by individuals in order to obtain nutritional benefits. However, food supplements are typically in the form of capsules or the like and have the disadvantage that they are inconvenient in that individual has to remember to take them. Food supplements of this type are typically not flavoured and are not attractive to many consumers.

Nutritional supplements have beefi incorporated into food products but the resulting food products can have an undesirable taste and the incorporation of the supplement can have a deleterious effect on the stability of the products.

Conjugated linoleic acid (CLA) is a conjugated dienoic fatty acid having 18 carbon atoms. As a result of the presence of the two double bonds in CLA, geometrical isomerism is possible and the CLA molecule or moiety may exist in a number of isomeric forms. The cis9, trans11 (“c9t11”) and trans10, cis12 (“t10c12”) isomers of CLA are generally the most abundant and beneficial pharmacological effects have been identified for each of these isomers.

U.S. Pat. No. 6,468,556 discloses the administration of CLA for inhibiting liver fat accumulation. However, this document is not concerned with the stability of its formulations or whether they have an acceptable taste and texture.

U.S. Pat. No. 7,115,759 and U.S. Pat. No. 6,608,222 disclose the production of CLA and its incorporation into various prepared food products. Neither document is concerned with solving the problems that occur when CLA is formulated into a food product or how these might be overcome.

WO 00/21379 relates to food substances based on substances derived from milk, which contain isomers of CLA.

EP-A-1618800 relates to compositions containing extracts of tomatoes. CLA may be included in the tomato extract.

WO 97/18320 discloses the preparation of a Ranch dressing comprising an inter-esterification product of sunflower oil and an oil containing CLA.

There remains a need for food products containing CLA that can have a low energy content (i.e., are low calorie) but still have good organoleptic properties such as taste and mouthfeel. We have now found certain compositions that solve these problems.

According to one aspect of the invention, there is provided a dressing composition comprising a fat phase, said fat phase comprising at least 90% by weight conjugated linoleic acid or a derivative thereof (CLA), wherein the dressing composition comprises from 15 to 60% by weight fat.

Preferably, the fat phase comprises at least 95% by weight CLA.

Advantageously, the dressing composition comprises from 15 to 45% by weight fat.

Preferably, the dressing composition comprises form 15 to 30% by weight fat.

Conveniently, the dressing composition is selected from the group consisting of Ranch dressing, Italian dressing, blue cheese dressing, Thousand Island dressing and French dressing.

Advantageously, the dressing composition is a Ranch dressing or an Italian dressing.

Conveniently, the dressing comprises vinegar.

Advantageously, the vinegar is balsamic vinegar.

Preferably, the dressing composition comprises from 2 to 55% by weight vinegar.

Conveniently, the dressing further comprises a dairy based product.

Advantageously, the dairy based product is yoghurt.

Preferably, the dairy based product is buttermilk.

Conveniently, the dressing comprises mayonnaise.

Advantageously, the dressing composition comprises a sweetener.

Preferably, the dressing composition comprises one or more additives selected from flavours, colouring agents, vitamins, acidity regulators, preservatives, emulsifiers, thickeners, antioxidants, dietary fibres and mixtures thereof.

Conveniently, the conjugated linoleic acid or a derivative thereof (CLA) is incorporated in the dressing composition in the form of a powder.

According to another aspect of the invention, there is provided a process for producing a dressing composition of the invention, which comprises admixing a fat phase which comprises at least 90% by weight conjugated linoleic acid or a derivative thereof (CLA), with an aqueous phase to give the dressing composition.

Preferably, the process further comprises the step of forming an emulsion of the fat phase with the aqueous phase.

Conveniently, the conjugated linoleic acid or a derivative thereof (CLA) is incorporated into the dressing composition in the form of a powder.

Advantageously, the powder is produced by spray drying the conjugated linoleic acid or its derivatives (CIA), or a fat comprising conjugated linoleic acid or its derivatives (CLA), with protein and/or carbohydrate.

According to a yet further aspect of the invention, there is provided a use of a dressing composition of the invention for a nutritional benefit.

Preferably, the benefit is a weight management effect.

Conveniently, the benefit is a reduced tendency to fluctuation of body weight.

Advantageously, the benefit is related to the prevention or treatment of atherosclerosis.

According to another aspect of the invention, there is provided a dressing composition comprising a fat phase having a fat A and a fat B, wherein fat A comprises at least 90% by weight conjugated linoleic acid or a derivative thereof (CLA), and wherein fat B is a liquid oil.

Conveniently, the fat phase comprises a blend of fat A with fat B.

Advantageously, the liquid oil comprises olive oil, extra virgin olive oil and/or native olive oil.

Preferably, fat A comprises at least 95% by weight CLA.

Conveniently, fat B comprises from 20 to 90% by weight of the fat phase.

Advantageously, fat B comprises from 35 to 90% by weight of the fat phase.

Preferably, fat B comprises from 20 to 90% by weight of the fat phase.

According to a further aspect of the invention, there is provided a process for producing a dressing composition of the invention, which comprises admixing a fat phase having a fat A and a fat B, wherein fat A comprises at least 90% by weight conjugated linoleic and/or a derivative thereof (CLA) and wherein fat B is a liquid oil, with an aqueous phase to give the dressing composition.

Conveniently, the process further comprises the step of mixing together fat A with fat B to give the fat phase before the fat phase is admixed with the aqueous phase.

Advantageously, the process comprises the steps of adding fat A and fat B to the aqueous phase separately.

The dressing compositions of the invention have good mouthfeel. They have a long shelf-life, with texture, appearance and colour remaining good.

Optionally, the dressing may comprise a flavouring substance. Flavouring substances may be used singly or in combination and include natural and artificial flavouring agents.

Sucrose, glucose and fructose may be specifically added or may be present as part of another component of the dressing. The dressing may comprise a sugar replacer and/or a sweetener.

Examples of suitable sweeteners are saccharin, aspartame, sucralose, neotame and acesulfame potassium, acesulfame, taumatine, cyclamate, and mixtures thereof. Preferred sweeteners are those selected from aspartame, acesulfame, sucralose and mixtures thereof.

Sugar replacers include, for example, sorbitol, mannitol, isomaltitol, xylitol, isomalt, lactitol, hydrogenated starch hydrolysates (HSH, including maltitol syrups) and mixtures thereof.

The dressing composition may comprise a dairy based product, such as yoghurt and/or buttermilk.

The dressing may additionally comprise a source of dietary fibre. Dietary fibres are complex carbohydrates resistant to digestion by mammalian enzymes, such as the carbohydrates found in plant cell walls and seaweed, and those produced by microbial fermentation.

Dressings of the invention optionally comprise one or more additional additives selected from colouring agents, vitamins, minerals, acidity regulators, preservatives, emulsifiers, antioxidants and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, when a vitamin or mineral is utilized the vitamin or mineral is selected from iron, zinc, folic acid, iodine, vitamin A, vitamin C, vitamin B2, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition. Citric acid is particularly useful.

Colouring agents including natural and artificial colours may optionally be used. Non-limiting examples of colouring agents include colours present in vegetable juices, riboflavin, carotenoids (e.g. p-carotene), tumeric, and lycopenes. However, the dressing of the invention may be free of extracts from tomato.

Preservatives may be selected from the group consisting of sorbate preservatives, benzoate preservatives, and mixtures thereof.

Emulsifiers may be selected from the group consisting of egg yolk and components thereof, such as lecithin, mustard, mono- and di-glycerides and derivatives thereof and fatty acid esters, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The dressing compositions of the invention may comprise one or more liquid oils, including vegetable oils such as olive oil, virgin olive oil, native olive oil and peanut oil. As used herein, the term “liquid oil” is meant to refer to fats that are liquid at room temperature, i.e. at about 25° C.

The fat phase in the dressing of the invention comprises at least 90% by weight, more preferably at least 95% by weight, even more preferably at least 98% by weight, and most preferably at least 99% by weight of the fat phase of conjugated linoleic acid or a derivative thereof (CLA). The upper limit of CLA in the fat phase may be 95% or 100% by weight. The amount of CLA in the fat phase is based on the total weight of fatty acids in the fat (calculated using fatty acid methyl ester analysis). The term “CLA”, as used herein refers to conjugated linoleic acid and its derivatives. The CLA may be used in the form of the free acid. Derivatives of conjugated fatty acids include salts and esters thereof, or a mixture of two or more of these materials. Salts are non-toxic, pharmaceutically acceptable and/or acceptable for use in food products and/or pharmaceuticals and include, for example, salts with alkali metals and alkaline earth metals such as sodium, calcium and magnesium, preferably sodium. Esters include, for example, mono-, di- and tri-glycerides and mixtures thereof, and C1 to C6 alkyl esters (where the alkyl group can be straight chain or branched), as well as esters formed with alcohols that are acceptable in food products or pharmaceutical products, such as are disclosed in EP-A-1167340, the contents of which are incorporated by reference herein. Suitable alcohols include terpene alcohols or sesquiterpene alcohols, for example menthol, isopulegol, menthenol, carveol, carvomenthenol, carvomenthol, isobornylalcohol, caryophyllenealcohol, geraniol, farnesol and citronellol.

The preferred form of CLA for use in the invention is as a glyceride. Particularly preferred are diglycerides and triglycerides, with triglycerides being even more preferred.

The CLA may comprise one isomer or a mixture of two or more different isomers including: cis, cis; cis, trans; trans, cis; and trans, trans isomers. Preferred isomers are the trans10, cis12 and cis9, trans 11 isomers (also referred to herein as t10c12 and c9t11, respectively), including these isomers in relatively pure form, as well as mixtures with each other and/or mixtures with other isomers. Typically, the fat phase of the dressing will comprise at least 20% by weight of the c9t11 isomer and/or at least 20% by weight of the t10c12 isomer. More preferably, the conjugated linoleic acid or derivative thereof comprises trans10, cis12 and cis9, trans11 isomers and the weight ratio of transl0, cis12 isomer to cis9, trans11 isomer or vice versa is at least 1.2:1, such as 1.3:1, even more preferably at least 1.5:1, e.g., in the range 1.5:1 to 100:1 or 1.5:1 to 10:1, such as a 60:40 or 80:20 mixture of the trans10, cis12: cis9, trans11 isomers. Particularly preferred are compositions comprising the trans10, cis 12 isomer or the cis9, trans 11 isomer as the major isomer component i.e., present in an amount of at least 55%, preferably at least 60%, more preferably at least 70%, even more preferably at least 75%, most preferably at least 80%, such as at least 90% or even 100% by weight based on the total amount of conjugated linoleic acid. For example, the CLA may comprise c9t11 and t10c12 isomers and the weight ratio of the c9t11 to t10c12 isomers may be from 99:1 to 1 to 99, preferably from 90:10 to 10:90 most preferably from 80:20 to 20:80.

CLA can be produced in conventional ways. For example, CLA can be produced by known methods, such as that described in EP-A-902082, the contents of which are incorporated herein by reference. CLA products that are enriched in one or more isomers are disclosed in WO 97/18320, the contents of which are also incorporated herein by reference.

The CLA is optionally blended with additional fatty acids or glycerides before being used in the fat of the present invention. When the compositions contain one or more fatty acids and/or glycerides in addition to the CLA, the additional fatty acid(s) and/or glycerides are preferably selected from liquid oils, such as soybean oil, sunflower oil, olive oil, flax seed oil rape seed oil and cotton seed oil; enzymically made fats; fish oils and fractions thereof; gamma linolenic acid and enriched mixtures thereof; and mixtures thereof; pinolenic acid, arachadonic acid and EPA (eicosapentaenoic) and DHA (docosahexaenoic). These other fatty acids may be present as free acids or derivatives in the same way as CLA and are preferably present as glycerides, more preferably triglycerides.

The CLA can be included in the dressing of the invention as an oil or in the form of a powder, such as a free flowing powder. CLA and its derivatives in powder form can be produced, for example, by spray drying CLA, or a fat comprising CLA, with protein and/or carbohydrate, with the powder typically comprising from 50 to 95% by weight of fat. A preferred powder comprises 70 to 90% by weight triglyceride of which at least 70% by weight is CLA. It has been found that use of the powder can give extra stability to the dressing. Preferably, the powder comprises at least 80% be weight, more preferably at least 90% by weight, most preferably at least 95% by weight, CLA or a derivative thereof.

The dressing compositions of the invention may be emulsions, such as oil-in-water or water-in-oil emulsions. They may separate out into different phases, or may be prepared so that they remain as an emulsion.

Preferably, the dressing of the invention is a low calorie product. For example, the dressing may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy_label.asp#3 and/or FAO Food And Nutrition Paper 77, Food energy—methods of analysis and conversion factors, Report of a Technical Workshop, Rome, 3-6 Dec. 2002, Food And Agriculture Organization of the United Nations, Rome, 2003, ISBN 92-5-105014-7.

Dressing compositions of the invention may be prepared to give a wide variety of different types of dressings. Dressing compositions of the invention may be prepared to give known types of dressings such as Ranch dressing, Italian dressing, blue cheese dressing, Thousand Island dressing and French dressings. Ranch dressing and Italian dressings are most preferred.

Ranch dressings generally comprise buttermilk or sour cream and other ingredients such as seasoning, garlic, mayonnaise and onions.

An Italian dressing generally comprises water, oil, lemon juice or vinegar, seasoning, garlic, onions and peppers.

A blue cheese dressing generally comprises blue cheese, mayonnaise, another ingredient such as garlic, seasoning, mustard, powder, lemon juice, vinegar, milk, sour cream and sugar.

Thousand Island dressing generally comprises mayonnaise and tomato ketchup, along with other ingredients including vegetable such as onions and peppers, another ingredient such as seasoning, lemon juice, Worcestershire sauce and sugar.

French dressing generally comprises oil, and preferably olive oil, and vinegar, preferably red or white wine vinegar or lemon juice along with other ingredients such as seasoning, sugar, mustard and garlic. Other suitable types of salad dressings for the use in the invention include caesar dressing and vinaigrette.

The compositions of the invention provide significant advantages in terms of weight management. The compositions have good taste and also good stability, both in their preparation and storage. Also, the compositions of the invention can offer improved nutritional balance and are easy to use. The compositions in the invention can offer a consumer a nutritional benefit in terms of weight management, in particular a reduced tendency to fluctuation of body weight and to prevent atherosclerosis.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

### Italian Style Dressing with Clarinol™

| Ingredient | % by weight |
|---|---|
| Vinegar | 21.0 |
| Clarinol ™ G-95 (95% conjugated linoleic | 10.0 |
| acid in triglyceride form) | |
| Olive oil | 10.0 |
| Sugar | 4.0 |
| Salt | 2.4 |
| Garlic | 1.0 |
| Red bell peppers | 0.5 |
| Xanthan gum Grindsted ® 80 (Danisco) | 0.5 |
| Onion | 0.4 |
| Garlic dried | 0.15 |
| Onion dried | 0.1 |
| Potassium sorbate | 0.1 |
| Parsley dried | 0.03 |
| Tomato paste | 0.1 |
| Annatto A-720-WS-AP (Chr. Hansen) | 0.007 |
| Caramel CA-45, 000C-WS (Chr. Hansen) | 0.007 |
| Calcium disodium EDTA | 0.0075 |
| Water till 100% | 49.7 |

The sugar, salt, potassium sorbate and EDTA are dissolved in warm water. The xanthan gum is dispersed in half of the vegetable oil and the oil-xanthan dispersion is slowly added to the water phase. Then the remaining olive oil and the Clarinoi^{rm} G-95 oil are slowly added. Then the vinegar, all the vegetable, herbs and spices as well as the colourants are added to form the Italian style dressing with Clarinol™ G-95.

### Example 2

### Italian Style Dressing with Clarinol™

| Ingredient | % by weight |
|---|---|
| Vinegar | 21.0 |
| Clarinol ™ G-95 (95% conjugated linoleic | 20.0 |
| acid in triglyceride form) | |
| Sugar | 4.0 |
| Salt | 2.4 |
| Garlic | 1.0 |
| Red bell peppers | 0.5 |
| Xanthan gum Grindsted ® 80 (Danisco) | 0.5 |
| Onion | 0.4 |
| Garlic dried | 0.15 |
| Onion dried | 0.1 |
| Potassium sorbate | 0.1 |
| Parsley dried | 0.03 |
| Tomato paste | 0.1 |
| Annatto A-720-WS-AP (Chr. Hansen) | 0.007 |
| Caramel CA-45, 000C-WS (Chr. Hansen) | 0.007 |
| Calcium disodium EDTA | 0.0075 |
| Water till 100% | 49.7 |

The sugar, salt, potassium sorbate and EDTA are dissolved in warm water. The xanthan gum is dispersed in half of the Clarinol™ G-95 oil and the oil-xanthan dispersion is slowly added to the water phase. Then the remaining Clarinol™ G-95 oil is slowly added. Then the vinegar, all the vegetable, herbs and spices as well as the colourants are added to form the Italian style dressing with Clarinol™ G-95.

### CLARINOL G-95

### Product Description

Clarinol™ G-95 is an oil high in isomers of Conjugated Linoleic Acid (CLA). The two main isomers present are cis-9, trans-11 (c9,t11) and trans-10, cis-12 (t10,c12) CLA, in a 50:50 ratio. Clarinol™ G-95 is made from natural safflower oil by a gentle, proprietary process.

Technical Characteristics (typical values)

| | |
|---|---|
| Free fatty acid as % oleic acid: | 0.7 |
| Peroxide value meq 02/kg: | 0.3 |
| Total CLA %: | 93 |
| c9, t11 + t10, c12 isomers %: | 89 |
| Trans fatty acids %: | 0.8 |
| Total saturated fatty acids %: | 0.5 |

The preparation of a material containing high amounts of triglycerides and diglycerides of CLA is set out below.

### Experimental

Materials

| | | |
|---|---|---|
| Clarinol A95 (NU-20080812- | 3000.0 | g |
| 003) | | |
| RMIM (Lux00205) | 33 | g (1 w/w % based on oil) |
| Glycerol | 313.5 | g (10.45 w/w % based on oil) |
| Material: | 10 | L reaction vessel, 50° C. |

### Experiment:

The reaction mixture was prepared by adding 313.5 g glycerol to 3333.0 g CLA A95. The mixture was stirred for 30 minutes at 50° C. During stirring nitrogen is blown through the reaction mixture. The reaction was started by adding 33.542 g RMIM enzyme (a commercially available lipase from Novozym) to the reaction mixture. Nitrogen is blown from the bottom of the reaction vessel through the reaction mixture during the whole reaction time. The mixture is also stirred rapidly during the whole reaction time. Samples are taken during the reaction to monitor the free fatty acid, diglyceride and water percentage in the reaction mixture. The reaction mixture was stopped when the diglyceride percentage was below 25%. The reaction is stopped by filtering the enzyme from the reaction mixture. The whole reaction mixture is brought to the pilot plant for separation on short path distillation (SPD).

### SPD Conditions:

| | | |
|---|---|---|
| Feed | 0.4 | l/hr |
| Film temperature | 200° | C. |
| Pressure | 8 * 10⁻³ | mbar |
| Residue condition temperature | 70/75° | C. |
| Wiper | 250 | rpm |

| | |
|---|---|
| Yield R1/D1 | 80.0%/20.0% |

The analytical results for the resulting high-CLA containing material is set out in the following table. The skilled reader will understand that the exact levels of components may vary from batch to batch, as is normal for such enzyme-mediated processing of natural materials.

| | Residue |
|---|---|
| Description | (G95 material) |
| C15:0 CLA | 0 |
| C14:0 CLA | 0.02 |
| C16:0 CLA | 0.3 |
| C16:1C CLA | 0.02 |
| C17:0 CLA | 0.1 |
| C18:0 CLA | 0.1 |
| CLA_TT CLA | 1.3 |
| CL911C CLA | 0.93 |
| CL1012 CLA | 0.9 |
| CL1113 CLA | 1.2 |
| C18:1T CLA | 0.02 |
| C18:1C CLA | 4.5 |
| CLA_OX CLA | 1.13 |
| C18:2T CLA | 0.54 |
| C18:2C CLA | 0.52 |
| TTnc CLA | 0.6 |
| C20:0 CLA | 0.04 |
| C20:1C CLA | 0.02 |
| C22:0 CLA | 0 |
| SAFA CLA | 0.5 |
| CT.ISO CLA | 88.6 |
| 911CT CLA | 44.1 |
| 1012TC CLA | 44.48 |
| TCLA CLA | 94 |
| poly HPSEC | 0.3 |
| TAG HPSEC | 82.2 |
| DAG HPSEC | 17.3 |
| MAG HPSEC | 0.1 |
| FFA HPSEC | |
| others HPSEC | 0.2 |
| Cu | |
| Ni | |
| Fe | |

1. A dressing composition comprising a fat phase, said fat phase comprising at least 90% by weight conjugated linoleic acid or a derivative thereof (CLA) and wherein the dressing composition comprises from 15 to 60% by weight lat.

2. A dressing composition as claimed in claim 1 wherein the fat phase comprises at least 95% by weight CLA.

3. A dressing composition of claim 1 which comprises from 15 to 45% by weight fat.

4. A dressing composition of claim 1 which comprises from 15 to 30% by weight fat.

5. A dressing composition of claim 1 selected from the group consisting of Ranch dressing, Italian dressing, blue cheese dressing, Thousand Island dressing and French dressing.

6. A dressing composition of claim 1 which is a Ranch dressing or an Italian dressing.

7. A dressing composition of claim 1, wherein the dressing comprises vinegar.

8. A dressing composition as claimed in claim 7, wherein the vinegar is balsamic vinegar.

9. A dressing composition as claimed in claim 7 comprising from 2 to 55% by weight vinegar.

10. A dressing composition of claim 1, wherein the dressing further comprises a dairy based product.

11. A dressing composition as claimed in claim 10, wherein the dairy based product is yoghurt.

12. A dressing composition as claimed in claim 10, wherein the dairy based product is buttermilk.

13. A dressing composition of claim 1, wherein the dressing comprises mayonnaise.

14. A dressing composition of claim 1 comprising a sweetener.

15. A dressing composition of claim 1 comprising one or more additives selected from flavours, colouring agents, vitamins, acidity regulators, preservatives, emulsifiers, thickeners, antioxidants, dietary fibres and mixtures thereof.

16. A dressing composition of claim 1 wherein the conjugated linoleic acid or a derivative thereof (CLA) is incorporated in the dressing composition in the form of a powder.

17. A process for producing a dressing composition of claim 1, which comprises admixing a fat phase which comprises at least 90% by weight conjugated linoleic acid or a derivative thereof (CLA), with an aqueous phase to give the dressing composition.

18. A process as claimed in claim 17, which further comprises the step of forming an emulsion of the fat phase with the aqueous phase.

19. A process as claimed in claim 17, wherein the conjugated linoleic acid or a derivative thereof (CLA) is incorporated into the dressing composition in the form of a powder.

20. A process as claimed in claim 19, wherein the powder is produced by spray drying the conjugated linoleic acid or its derivatives (CLA), or a fat comprising conjugated linoleic acid or its derivatives (CLA), with protein and/or carbohydrate.

21. A method for providing a nutritional benefit comprising consuming a dressing composition of claim 1.

22. The method as claimed in claim 21, wherein the benefit is a weight management effect.

23. The method as claimed in claim 21, wherein the benefit is a reduced tendency to fluctuation of body weight.

24. The method as claimed in claim 21, wherein the benefit is related to the prevention or treatment of atherosclerosis.
